(19) United States
(12) Patent Application Publication
(10) Pub. No.: US 2015/0012643 A1
(43) Pub. Date: Jan. 8, 2015

(54) INFORMATION PROCESSING SYSTEM, DEVICE MANAGEMENT APPARATUS, AND ASSET MANAGEMENT APPARATUS

(71) Applicant: Yuuki OGAWA, Kanagawa (JP)

(72) Inventor: Yuuki OGAWA, Kanagawa (JP)

(73) Assignee: RICOH COMPANY, LTD., Tokyo (JP)

(21) Appl. No.: 14/284,496

(22) Filed: May 22, 2014

(30) Foreign Application Priority Data
Jul. 8, 2013 (JP) 2013-142393

(51) Int. Cl. H04L 12/26; H04L 12/24

(52) U.S. Cl. CPC H04L 43/0811; H04L 41/5016
USPC 709/224

(57) ABSTRACT

An information processing system includes an asset management apparatus; and a device management apparatus; wherein the asset management apparatus includes a storage part configured to store asset information representing an asset status of a device as an asset, and the device management apparatus includes a reception part configured to repeatedly receive operating information representing an operating condition of the device, an acquisition part configured to acquire the asset information from the asset management apparatus, and a determination part configured to determine whether to exclude a first period in which the asset status is a predetermined status from a second period for calculating an availability rate of the device based on the received operating information.

### BACKGROUND OF THE INVENTION

1. Field of the Invention

An aspect of this disclosure is related to an information processing system, a device management apparatus, and an asset management apparatus.

2. Description of the Related Art

A device vender providing an image forming device and a customer sometimes enter into a service level agreement (SLA) to ensure performance of the provided device. The SLA stipulates warranty information about performance of the device based on, for example, an availability rate as an indicator.

As a means to execute the SLA, a system may be used, which monitors the condition of the device remotely via a network (hereinafter called “device management system”). It is expected to improve the availability rate by quickly dealing with a fault of the device, which is detected by the device management system.

However, even if the device management system detects the fault of the device, it may be inappropriate to include the period during which the fault has occurred in a period used to calculate the availability rate. For example, when the device management system detects out of toner for a device, and when the customer has not used the device substantially and the customer does not need its maintenance, a period during which the out of toner has occurred should be excluded from the period used to calculate the availability rate. An example of the case when the customer has not used the device substantially includes the case when the device is abandoned or transferred to another division due to an administrative reason about its asset management policy.

### SUMMARY OF THE INVENTION

In one aspect, the present disclosure provides an information processing system, a device management apparatus, and an information processing method, which substantially eliminate one or more problems caused by the limitations and disadvantages of the related art.

In an aspect of this disclosure, there is provided an information processing system including an asset management apparatus; and a device management apparatus; wherein the asset management apparatus includes a storage part configured to store asset information representing an asset status of a device as an asset, and the device management apparatus includes a reception part configured to repeatedly receive operating information representing an operating condition of the device, an acquisition part configured to acquire the asset information from the asset management apparatus, and a determination part configured to determine whether to exclude a first period in which the asset status is a predetermined status from a second period for calculating an availability rate of the device based on the received operating information.

According to another embodiment of this invention, there is provided a device management apparatus including a reception part configured to repeatedly receive operating information representing an operating condition of a device; an acquisition part configured to acquire asset information representing an asset status of the device as an asset from a storage part storing the asset information; and a determination part configured to determine whether to exclude a first period in which the asset status is a predetermined status from a second period for calculating an availability rate of the device based on the received operating information.

According to another embodiment of this invention, there is provided an asset management apparatus including an identification part configured to identify one of relationships defined based on the operating condition represented by the operating information received from the device management apparatus as claimed in claim 5 and the asset status stored in the storage part and determine whether the identified one of the relationships is a predetermined relationship; and an output part configured to output a confirmation request for the asset information when the identification part determines that the identified one of the relationships is a predetermined relationship.

### BRIEF DESCRIPTION OF THE DRAWINGS

Other objects and further features of embodiments may become apparent from the following detailed description when read in conjunction with the accompanying drawings, in which:

FIG. 1 is a diagram showing a configuration of an information processing system according to an embodiment of the present invention;

FIG. 2 is a diagram showing a hardware configuration of a device management apparatus according to the embodiment;

FIG. 3 is a diagram showing a system configuration of the information processing system according to the embodiment;

FIG. 4 is a sequence diagram for explaining a process performed by the information processing system;

FIG. 5 is a table including information stored in a device condition history storage part;

FIG. 6 is a diagram showing an example of a search result for asset information;

FIG. 7 is a flowchart showing a process to identify one of maintenance statuses for a device;

FIG. 8 is a table including asset statuses and maintenance statuses stored in the device condition history storage part;

FIG. 9 is a diagram showing an example of search results for asset information;

FIG. 10 is a table including asset statuses and maintenance statuses stored in the device condition history storage part;

FIG. 11 is a diagram showing an advantage derived from this embodiment.

FIG. 12 is a flowchart showing a process to determine whether it is required to confirm the asset information;

FIG. 13 is a table including information stored in an allowed period storage part;

FIG. 14 is a flowchart showing a process to output a confirmation request; and

FIG. 15 is a table including information stored in an output conditions storage part.

### DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

It is to be noted that, in the explanation of the drawings, the same components are given the same reference numerals, and explanations are not repeated.

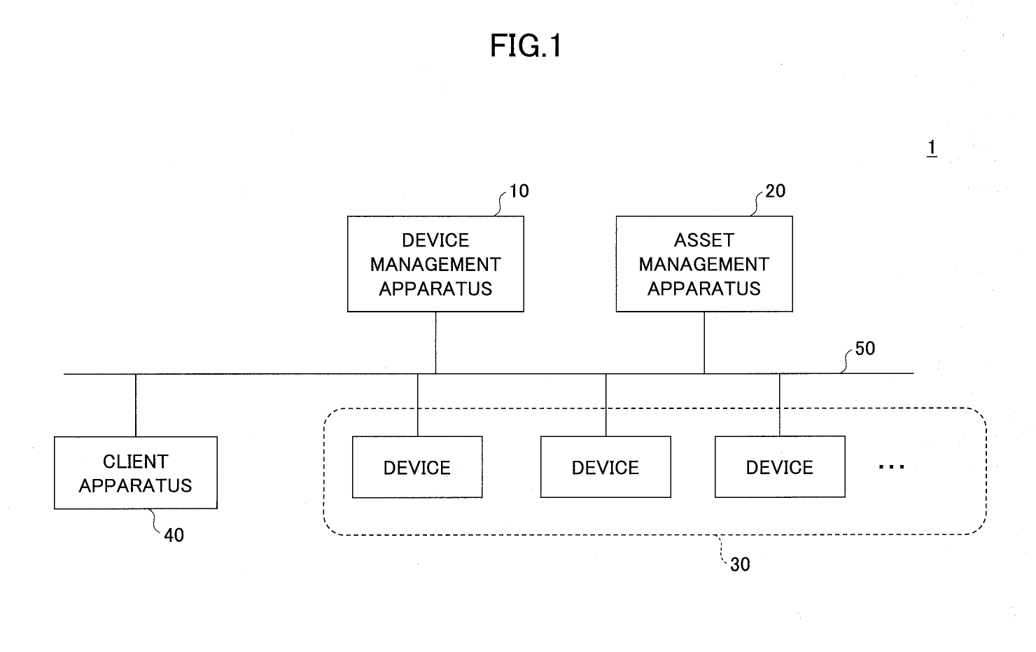

FIG. 1 is a diagram showing a configuration of an information processing system according to an embodiment of the present invention. As shown in FIG. 1, a device management apparatus 10, an asset management apparatus 20, a plurality of devices 30, and a client apparatus 40 are connected via a network such as local area network (LAN), a wide area network (WAN), or the like.

For example, the devices 30 may include an image forming apparatus such as a multifunction peripheral, a copier, a scanner, etc. In addition, the devices may include electronic equipment other than the image forming apparatus, such as a projector, an electronic blackboard, a TV conference system, a digital still camera, etc.

The device management apparatus 10 may include one or more computers which monitor the operating conditions of the devices 30 remotely. For example, the device management apparatus 10 may repeatedly (periodically or cyclically) collect information about each device 30 (hereinafter called “device information”) including information representing the operating condition of each device 30 (hereinafter called “operating condition”). The operating information may include information about each device 30, which indicates an abnormal status or trouble or a lack of supplies. Also, the operation information may include attribute information which may be updated depending on the usage of the device 30 such as a counter. The counter may be prepared for each measurement target such as a printing operation or a scanning operation. The counter may be incremented in response to the operation, for example.

In this embodiment, the operating condition may indicate a normal condition or an abnormal condition. In the normal condition, the performance of the device 30 does not decrease and all functions of the device 30 work well. In the abnormal condition, the performance of the device 30 decreases or one of the functions does not work correctly. Also, the abnormal condition may include a condition in which supplies such as toner or paper run short. How a condition is defined as a normal condition may be defined in a service level agreement (SLA) made and entered into by and between a vendor or a maintenance business operator and a user (a client) of the device 30.

A period in which the operating condition is normal may be included in a mean time between failures (MTBF) in calculating an availability rate for the device 30. A period in which the operating condition of the device 30 is abnormal may be included in a mean time to repair (MTTR) in calculating an availability rate for the device 30.

In the embodiment, the following equation (1) is used to calculate the availability rate.

Availability Ratio=MTBF/(MTBF+MTTR) (1)

However, the equation for calculating the availability rate may be defined in the SLA.

The asset management apparatus 20 is a computer for managing asset information about each device 30. The asset information is required for general asset management, for example. In this embodiment, a status of the device 30 as an asset (hereinafter called “asset status”) may be included in the asset information other than the attribute information of the device 30. The asset status of the device 30 may indicate a status in a life cycle of the asset management. In this embodiment, the asset status may include “accepted”, “in stock”, “deploying”, “working”, “transferring”, and “abandoned” statuses. The “accepted” status indicates that the device 30 is accepted. The “in stock” status indicates that the device 30 has been accepted and managed in stock. The “deploying” status indicates that the device 30 has been deployed to a predetermined location. The “working” status indicates that the device 30 is working in an operational phase. The “transferring” status indicates that the device 30 is being transferred to another location. The “abandoned” status indicates that the device 30 has been abandoned. The user can operate the device 30 in the “working” status. The user of the asset management apparatus 20 may freely define the asset statuses.

The client apparatus 40 is an information processing device which works as a user interface for the device management apparatus 10 and the asset management apparatus 20. The user may input a command for the device management apparatus 10 or the asset management apparatus 20 via the client apparatus 40. Examples of the client apparatus 40 are a personal computer (PC), a tablet, a smart phone, and a cell phone.

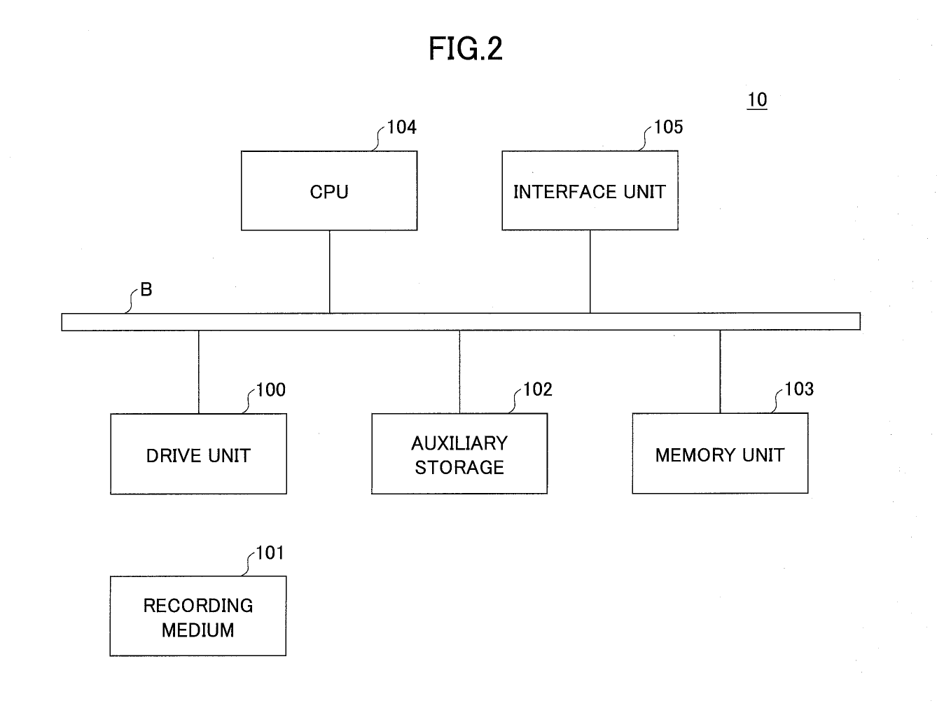

FIG. 2 is a diagram showing a hardware configuration of the device management apparatus according to the embodiment. The device management apparatus 10 in the FIG. 2 includes a drive unit 100, an auxiliary storage 102, a memory unit 103, a CPU 104, and an interface unit 105, all of which are connected via a bus B.

The program which implements processes performed in the device management apparatus 10 may be provided with a recording medium 101 such as a CD-ROM. When the recording medium storing the program is set in the drive unit 100, the program is installed from the recording medium 101 into the auxiliary storage 102 via the drive unit 100. However, the program is not necessarily to be installed from the recording medium 101. The program may be downloaded from another computer via a network. The auxiliary storage 102 stores the installed program as well as the required files and data.

The memory unit 103 may store the program loaded from the auxiliary storage 102 responding to an instruction to start the program. The CPU 104 may perform functions of the device management apparatus 10 according to the program stored in the memory unit 103. The interface unit 105 may be used as an interface to connect to the network.

The device management apparatus 10 may be formed by one or more computers. Also, the asset management apparatus 20 may have similar hardware, and the asset management apparatus 20 may be formed by one or more computers. Furthermore, both the device management apparatus 10 and the asset management apparatus 20 may be implemented in a single system including one or more computers.

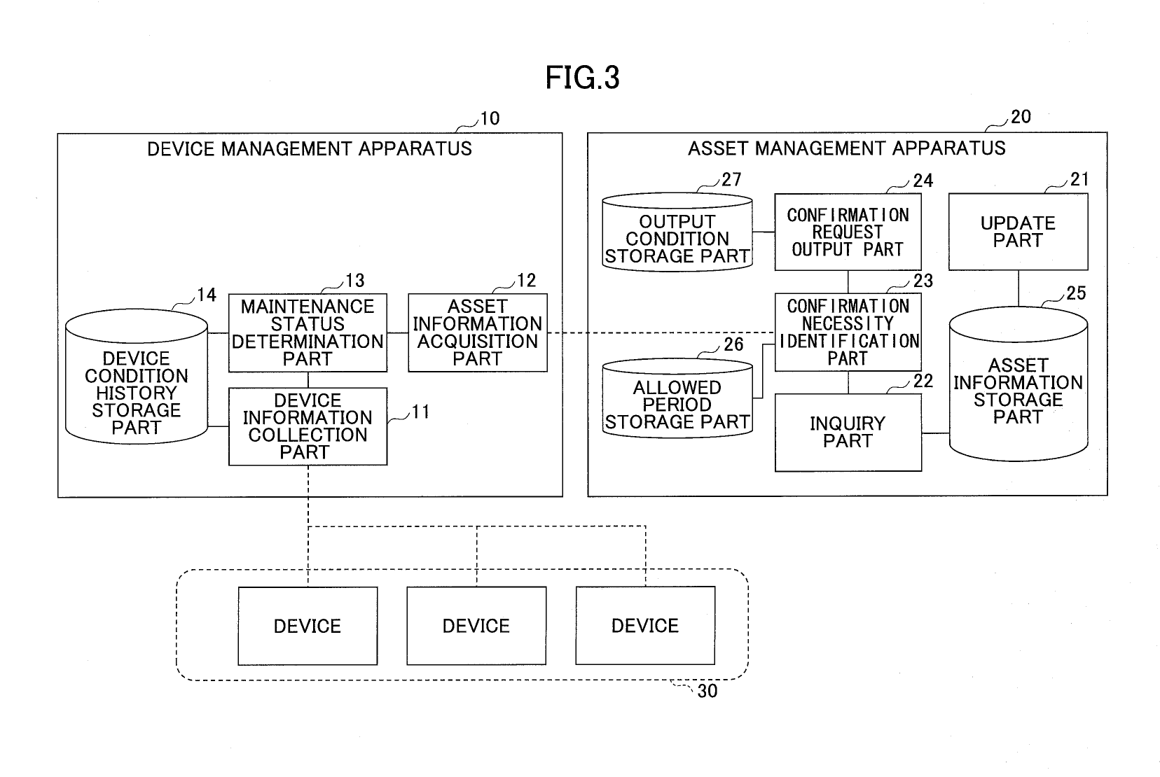

FIG. 3 is a diagram showing a system configuration of the information processing system according to the embodiment. From the information processing system 1 shown in FIG. 1, the device management apparatus 10 shown in FIG. 3 may include a device information collection part 11, an asset information acquisition part 12, and a maintenance status determination part 13. Each part may be implemented by processes performed by the CPU 104 according to instructions of the program installed in the device management apparatus 10. The device management apparatus 10 may use a device condition history storage part 14. The device condition history storage part 14 may be implemented by the auxiliary storage 102 or a storage unit connected to the device management apparatus via the network.

The device information collection part 11 may collect (receive) device information from each device registered as a collection target. The device information collection part 11 may collect the device information by repeatedly (periodically or cyclically) transmitting a request for the device information to each device 30. When the device 30 detects trouble, the device 30 transmits the device information to the device information collection part 11. The device information collection part 11 may store operating information included in the collected or received device information in the device condition history storage part 14.

The asset information acquisition part 12 may acquire from the asset management apparatus 20 asset information about the devices 30, the device information of which is collected.

The maintenance status determination part 13 may identify, from a viewpoint of whether the vendor has a duty for the maintenance of each device 30 based on the contract such as SLA, a status of the device 30 (hereinafter called “maintenance status”), the device information of which has been collected according to an asset status represented in the asset information acquired by the asset information acquisition part 12. The maintenance status may be categorized into “Normal (maintenance target)”, “Abnormal (maintenance target)”, “Normal (non-maintenance target)”, and “Abnormal (non-maintenance target)”. In the “Normal (maintenance target)” status, the operating condition of the device 30 is normal and the asset status indicates that the vendor has a duty to maintain the device 30. In the “Abnormal (maintenance target)” status, the operating condition of the device 30 is abnormal and the asset status indicates that the vendor has a duty to maintain the device 30. In the “Normal (non-maintenance target)” status, the operating condition of the device 30 is normal and the asset status indicates that the vendor does not has a duty to maintain the device 30. In the “Abnormal (non-maintenance target)” status, the operating condition of the device 30 is abnormal but the asset status indicates that the vendor does not has a duty to maintain the device 30.

In this embodiment, when the asset status indicates “working”, the vendor has a duty to maintain the device 30. This is because the user should be able to use the working device 30, and an abnormal operating condition of the device 30 in such a state may inconvenience the user directly. On the other hand, in other statuses except “working”, the user cannot use the device 30 in an asset management procedure, and the operating condition of the status is unlikely to be a direct cause of inconveniencing the user. Thus, the vendor does not have a duty to maintain the device 30 in asset statuses other than “working”. However, it may be defined which asset status follows the duty depending on the contract such as a SLA.

The maintenance status determination part 13 may associate information representing the maintenance status as an identification result (hereinafter called “maintenance status information”) with the operating information about the device 30 as an identification target, and may store the information in the device condition history storage part 14.

Thus, the operating information, the asset information, and the maintenance status information for the device 30 are stored in the device condition history storage part 14 every time when the device information for the device 30 is collected.

The asset management apparatus 20 may include an update part 21, an inquiry part 22, a confirmation necessity determination part 23, and a confirmation request output part 24. Each part may be implemented by processes performed by the CPU of the asset management apparatus 20 according to instructions of the program installed in the asset management apparatus 20. The asset management apparatus 20 may use an asset information storage part 25, an allowed period storage part 26, and an output condition storage part 27. These storage parts 25-27 may be implemented by an auxiliary storage of the asset management apparatus 20 or a storage unit connected to the asset management apparatus 20 via the network.

The update part 21 may execute an update of the asset information stored by the asset information storage part 25. The process executed by the update part 21 is performed in response to an input made by a user for reflecting a change of the asset status for the device 30.

The inquiry part 22 may send a query for the asset information storage part 25 to specify the asset information which meets a specified condition.

In response to a request for the asset information from the device management apparatus 10, the confirmation necessity determination part 23 may determine whether a user's confirmation about validity of the asset information is required. For example, if the asset information is possibly incorrect, it is determined that the confirmation is required. The determination may be made by referring to the allowed period storage part 26. The allowed period storage part 26 stores an allowed period for each abnormal operating condition, in which the operating condition may continue. The confirmation necessity determination part 23 may determine that the user's confirmation is required for the asset information for the device 30 for which the time during which the operating condition is abnormal exceeds the allowed period for the operating condition regardless of the asset status indicating that the vendor has a duty to maintain the device 30. The confirmation necessity determination part 23 may obtain the asset information relating to the request via the inquiry part 22, and may transmit the acquired asset information to the device management apparatus 10 as a response.

When the confirmation necessity determination part 23 determines that the confirmation about the asset information is required, the confirmation request output part 24 may output a confirmation request for the asset information. The output condition storage part 27 may store information for specifying the output confirmation request. Thus, the confirmation request based on the result determined by the confirmation necessity determination part 23 is filtered by the output condition storage part 27.

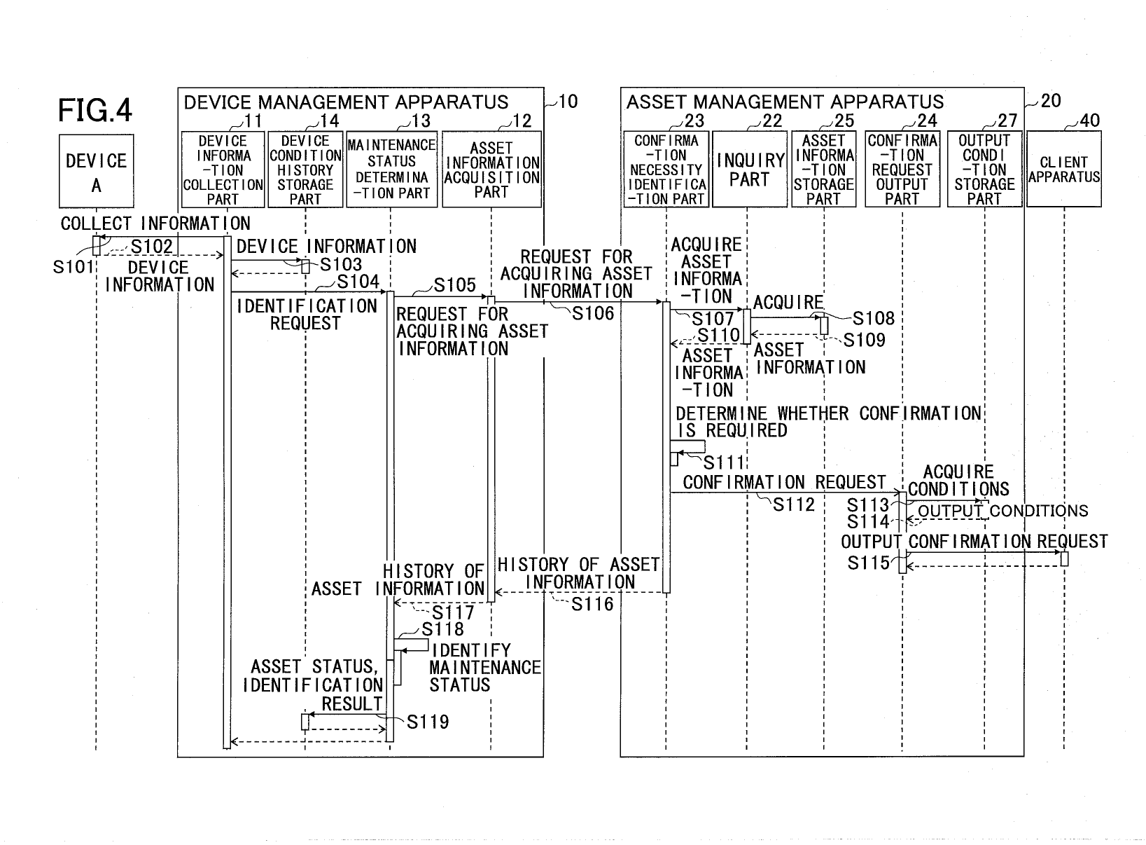

In the following, processes performed by the information processing system 1 are discussed. FIG. 4 is a sequence diagram for explaining a process performed by the information processing system.

For example, when the device information collection part 11 periodically or cyclically collects the device information from each device 30 (steps S101 and S102), the device information collection part 11 stores the collected device information in the device condition history storage part 14 (step S103).

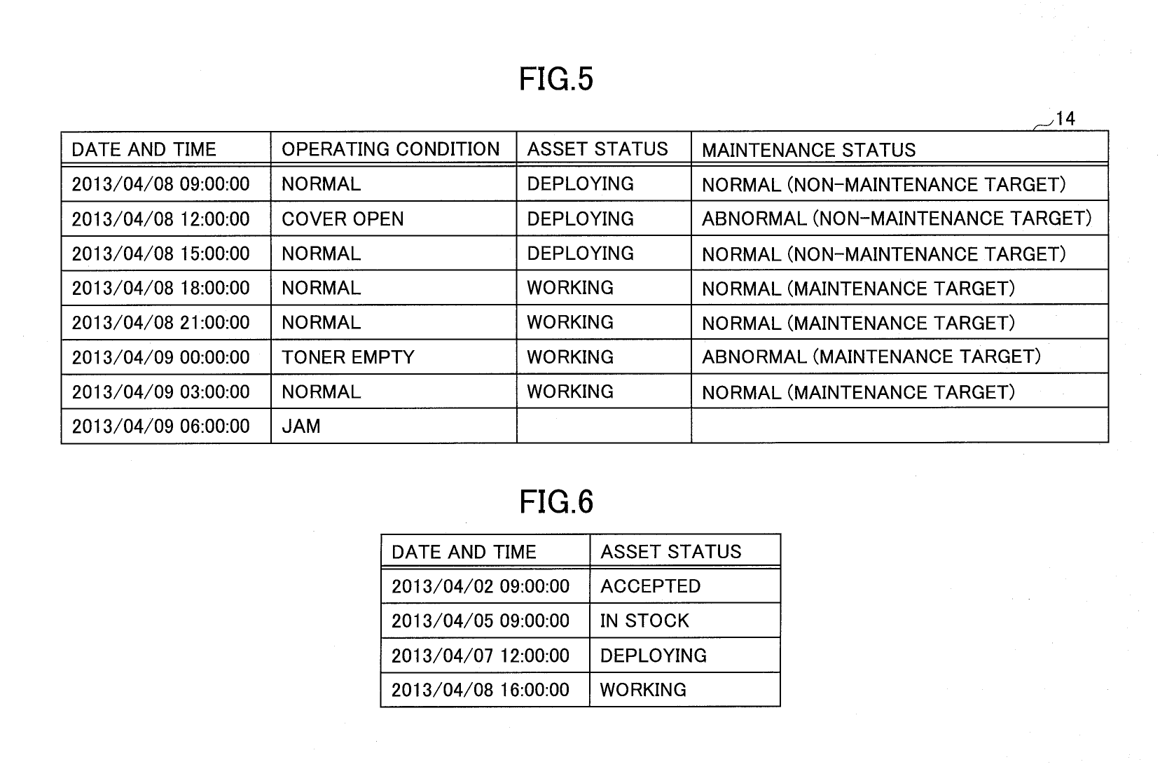

FIG. 5 is a table including information stored in device condition history storage part 14. FIG. 5 shows a record for a device 30 for convenience (hereinafter called “device A”). The device condition history storage part 14 may include a single table shown in FIG. 5 for each device 30 to store its record. Alternatively, the device condition history storage part 14 has a single table shown in FIG. 5 to store records of any devices 30.

As shown in FIG. 5, each record of the table stored in the device condition history storage part includes date and time, the operating condition, the asset status, and the maintenance status. The date and time indicate the date and time when the device information has been collected or received from the device A. The operating condition is represented in the operating information included in the device information. The asset status is represented in the asset information for the device A when the device information has been collected or received. The maintenance status indicates the maintenance status of the device A.

As shown in FIG. 5, the bottom record has been registered in the step S103. Thus, in the step S103, a new record is added to store values for the date and time and the operating condition in the record.

The other items of the device information other than the operating information may be stored in the device condition history storage part 14. For example, the device information for each device 30 includes identification information (hereinafter called “device ID”). The device ID may be a serial number, a MAC address or an IP address, which identifies the individual device 30. By referring to the device ID, the device information collection part 11 may identify one of the devices 30 corresponding to the collected device information. When a request for the device information and a response of the device information are performed in synchronization, the device information collection part 11 may identify the device 30 corresponding to the collected device information by referring to the destination of the request for the device information.

The following steps are executed for the devices 30, the device information of which is collected. However, as a matter of convenience, the steps are discussed only for the device A.

After the step S103, the device information collection part 11 transmits a request to the maintenance status determination part 13 for identifying the maintenance status of the device A at present (step S104). The request includes the device ID of the device A and a history of the device status information. The history of the device status information for the device A includes the last N records or the records of the last M days stored in the device condition history storage part 14 for the device A.

Subsequently, the maintenance status determination part 13 sends a request to the asset information acquisition part 12 for acquiring the asset information about the device A by specifying the device ID and the history of the device information for the device A (step S105). The asset information acquisition part 12 transmits to the confirmation necessity determination part 23 of the asset management apparatus 20 a request for acquiring the asset information for the device A by specifying the device ID and the history of the device information for the device A (step S106). Next, the confirmation necessity determination part 23 sends a request to the inquiry part 22 for acquiring the asset information related to the device ID by specifying the device ID of the device A (step S107).

The inquiry part 22 queries the asset information storage part 25 for the asset information connected to the device ID (steps S108, S109).

FIG. 6 is a diagram showing an example of search results for the asset information. In the example shown in FIG. 6, the history of the asset information for the device A is requested. The result is displayed based on the condition that the asset information storage part 25 stores transitions of the asset status as a history for each device 30. For example, a new record is created in the asset information storage part 25 every time when the asset status of the device 30 is updated, and the created record stores the updated asset status. Each record includes date and time and the asset status. The date and time indicates the date and time when the asset status is updated. The asset status indicates the updated asset status.

When step S104 is executed every time when the device information is collected as in this embodiment, a single record related to the latest asset status may be selected as a target for query. If step S104 and subsequent steps are executed in a batch process (i.e. the asset statuses and items about the maintenance target of the multiple records for the same device 30 in the device condition history storage part 14 are stored at once), it is better to output the query result including the previous asset information (history of the asset information) as shown in FIG. 6. Showing the asset information history enables the user in specifying the asset information corresponding to the past operating condition.

Subsequently, the confirmation necessity determination part 23 determines whether a user's confirmation about validity of the asset information is required by verifying the history of the asset information and the history of the device status information for the device A (step S111).

When it is determined that the confirmation is required, the confirmation necessity determination part 23 notifies the confirmation request output part of a confirmation request for the asset information (step S112). The confirmation request output part 24 obtains output conditions from the output condition storage part 27 (steps S113, S114), and determines whether the content of the confirmation request is identical with the output condition. When the content of the confirmation request is identical, the confirmation request output part 24 outputs the confirmation request for a predetermined destination (step S115). In FIG. 4, the confirmation request is transmitted for the client apparatus 40. The user can understand whether the asset information is valid or not by checking the confirmation request. As a result, the user may correct errors of the asset information.

Next, the confirmation necessity determination part 23 transmits the history of the asset information for the device A to the asset information acquisition part 12 as a response (step S116). The asset information acquisition part 12 transmits the history of the asset information for the device A to the maintenance status determination part 13 in return (step S117).

Subsequently, the maintenance status determination part 13 identifies the maintenance status of the device A based on the asset status represented by asset information corresponding to the present time in the history of the asset information (hereinafter called “targeted asset information”) (step S118). The asset information corresponding to the present time is the latest asset information (the date and time is prior to the current date and time) in the history of the asset information. Note that a continuance period of each asset status is from the present date and time of the asset status to the date and time of the subsequent asset status, for example.

When only the latest asset information time is acquired, it corresponds to the targeted asset information. If step S104 and subsequent steps are executed in batch process (i.e. the asset statuses and items about the maintenance target of the multiple records for the same device 30 in the device condition history storage part 14 are stored at once), the targeted asset information may vary depending on each record. Thus, the targeted asset information for each record is the asset status in the continuance period including the date and time of the record (i.e. the latest (last) asset information at the date and time of each record).

Next, the maintenance status determination part stores the asset status indicated by the target asset information and the maintenance status indicated by the maintenance status information (as an identification result) in the record corresponding to the targeted asset information and the identification result (e.g. the last record in FIG. 5) in the device condition history storage part 14 (step S119).

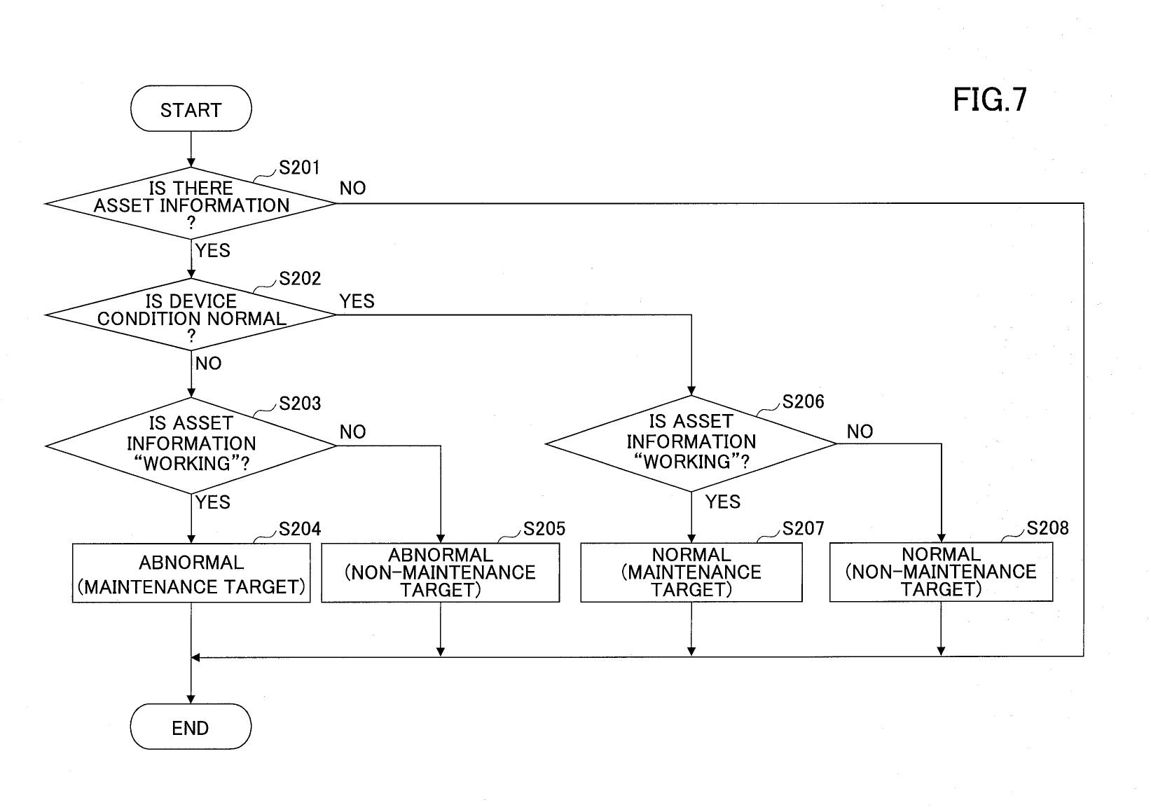

Next, the details of step S118 are discussed. FIG. 7 is a flowchart showing a process to identify one of maintenance statuses for a device. In FIG. 7, a record, which is targeted to process in the device condition history storage part 14, (e.g. the last record in FIG. 5), is called “target record”.

In step S201, the maintenance status determination part 13 determines whether the asset information is acquired. Thus, it is determined whether the history of the asset information input in step S117 shown in FIG. 4 is empty. If the asset information for the device A is not stored in the asset information storage part 25, the history is empty.

When the asset information is not acquired (No in the step S201), since the maintenance status cannot be identified, the maintenance status determination part 13 finishes the process in FIG. 7. In this case, the asset status and the maintenance status are not necessarily to be stored for the target record of the device condition history storage part 14.

When the asset information is acquired (Yes in the step S201), the maintenance status determination part 13 determines whether the operating condition of the target record is normal (or abnormal) (step S202). When the operating condition is not normal (No in the step S202), the maintenance status determination part 13 determines whether the asset status indicated by the targeted asset information is “working” (step S203). When the asset status is “working” (Yes in the step S203), the maintenance status determination part 13 determines that the maintenance status for the target record is “abnormal (maintenance target) (step S204). When the asset status is not “working” (No in the step S203), the maintenance status determination part 13 determines that the maintenance status for the target record is “abnormal (non-maintenance target) (step S205).

On the other hand, when the operating condition of the target record is “normal” (Yes in the step S202), the maintenance status determination part 13 determines whether the asset status indicated by the targeted asset information is “working” (step S206). When the asset status is “working” (Yes in the step S206), the maintenance status determination part 13 determines that the maintenance status for the target record is “normal (maintenance target) (step S207). When the asset status is not “working” (No in the step S206), the maintenance status determination part determines that the maintenance status for the target record is “normal (non-maintenance target) (step S208).

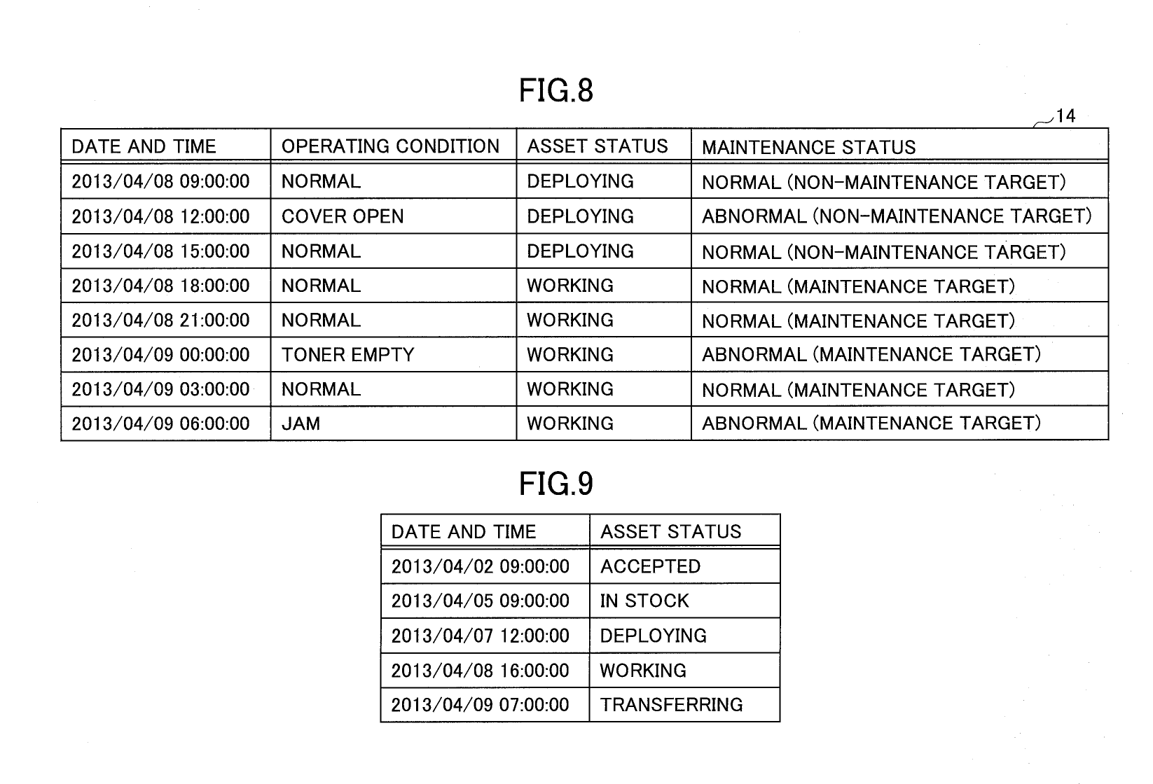

The maintenance status determined in FIG. 7 and the asset status indicated by the targeted asset information are stored in the target record. The stored contents of the device condition history storage part 14 are shown in FIG. 8 and FIG. 9.

FIG. 8 is a table including asset statuses and maintenance statuses stored in the device condition history storage part 14. In FIG. 8, the last record in FIG. 6 is the target record. The last record indicates the asset status and the maintenance status when the last asset information entry in the history of the asset information shown in FIG. 6 is the targeted asset information. In this case, the operating condition is not “normal”. Also, the asset status indicated by the targeted asset information is “working”. Thus, the maintenance status is “abnormal (maintenance target).

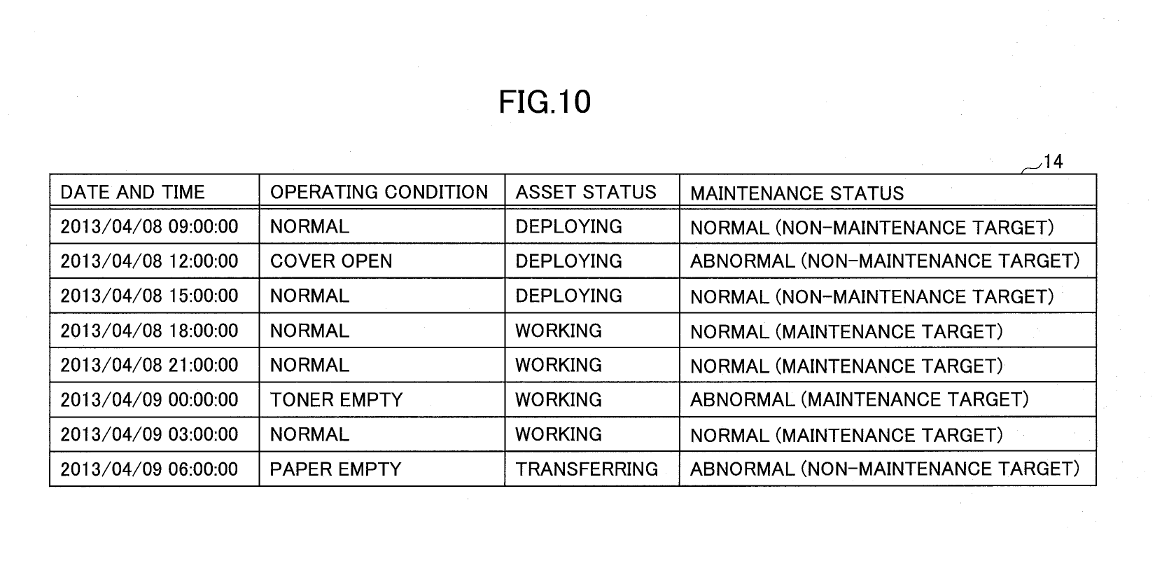

It is assumed that the query results of the asset information for the device A are as shown in FIG. 9. FIG. 9 is a diagram showing an example of the query results for asset information. It is different from an example shown in FIG. 6 in that the asset status indicated by the targeted asset information is “transferring”. In this case, the maintenance status determined in FIG. 7 and the asset status indicated by the target asset information are stored as shown in FIG. 10.

FIG. 10 is a table including asset statuses and maintenance statuses stored in the device condition history storage part 14. In FIG. 10, the maintenance status of the last record is “abnormal (non-maintenance target). The reason why the status indicates “non-maintenance target” is that the asset status is not “working”.

The subject to be compared with the asset status indicated by the target asset information in step S203 in FIG. 7 is not necessarily only “working”. For example, a list of asset statuses in which the vendor has a duty to maintain the device 30 (or does not have a duty to maintain the device 30) may be stored in the auxiliary storage 102. The maintenance status determination part 13 may determine whether the asset status indicated by the target asset information is included in the list.

By using the device condition history storage part 14 as shown in FIG. 8 or FIG. 10, a period in which the vendor does not have a duty to maintain may be excluded from a period to calculate the availability rate of the device A. In particular, a period in which the maintenance status is “normal (non-maintenance target)” or “abnormal (non-maintenance target)” may be excluded from the MTBF or MTTR in the equation (1). As a result, the adequacy of the calculation result for the availability rate may be improved for the contract such as the SLA.

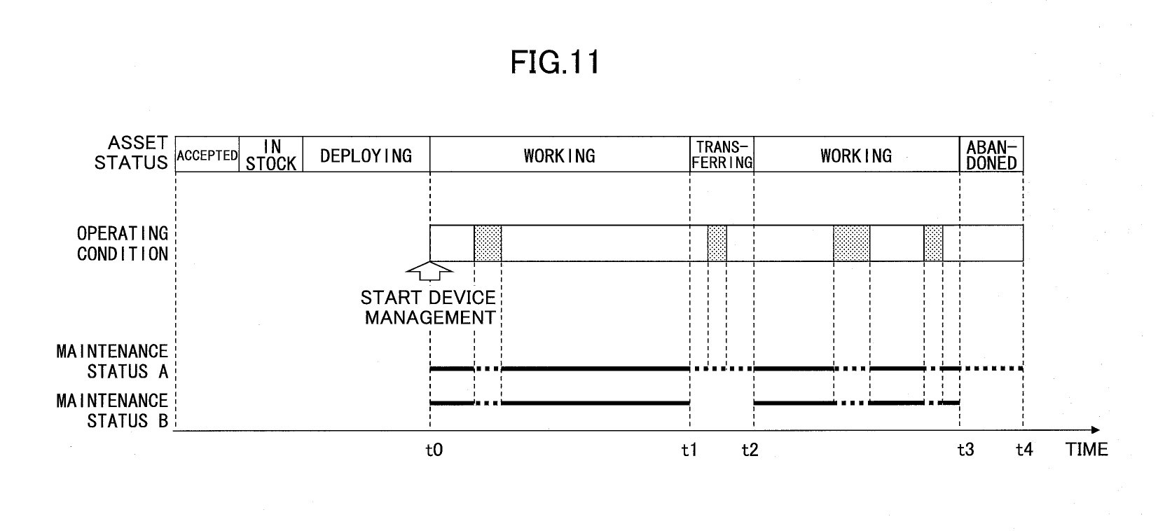

FIG. 11 is a diagram showing an advantage derived from this embodiment. In FIG. 11, the horizontal axis indicates time. The time elapses from left to right in FIG. 11.

The vertical axis lists an asset status, an operating condition, a maintenance status A, and a maintenance status B. Each shaded box indicates that the operating condition is not “normal”. The others indicate that the operating condition is “normal”. In FIG. 11, it is assumed that the device management apparatus 10 has started to collect the device information at the time t0 when the asset status is changed into “working”. Thus, the operating condition is valid since the time t0.

The maintenance status A indicates a transition of the maintenance status without applying the embodiment of the present invention (i.e. the maintenance status is determined regardless of the asset status). The maintenance status B indicates a transition of the maintenance status according to the embodiment of the present invention (i.e. the maintenance status is determined depending on the asset status).

Solid lines indicate continuance periods of “normal (maintenance target)” states in the transition of the maintenance status. Dotted lines indicate continuance periods of “abnormal (maintenance target)” states in the transition of the maintenance status. No lines indicate continuance periods of “normal (non-maintenance target)” and “abnormal (non-maintenance target). According to the maintenance status A, the vendor always owes a duty to maintain the device after t0. Thus, the entire period is included in a period to calculate the availability rate (a period affecting the calculation of the availability rate). However, according to the maintenance status B, periods from t1 to t2 and from t3 to t4 are excluded from the period to calculate the availability rate.

When the availability rate is calculated according to FIG. 8 or FIG. 10, the period for each operating condition is from the date and time of the operating condition to the date and time of the subsequent operating condition. For example, “cover open” of the second record in FIG. 8 and FIG. 10 may continue in the period between the date and time of the record and the date and time of the subsequent record (the operation condition is normal).

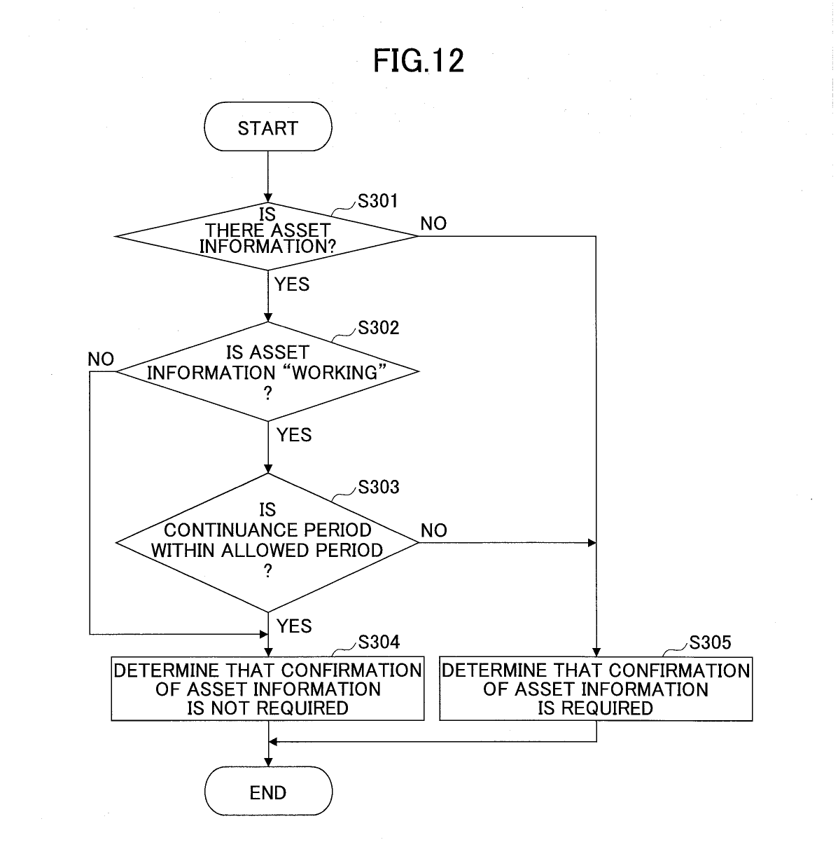

Subsequently, the details of step S111 shown in FIG. 4 are discussed. FIG. 12 is a flowchart showing a process to determine whether it is required to confirm the asset information.

In step S301, the confirmation necessity determination part 23 determines whether the asset information for the device A is acquired. When the asset information is acquired (Yes in the step S301), the confirmation necessity determination part 23 determines whether the asset status indicated by the latest asset information in the history of the asset information is “working” (S302). When the asset status is “working” (Yes in step S302), the confirmation necessity determination part 23 determines, by referring to both the history of the device information and the allowed period storage part 26, whether the continuance period of the operating condition indicated by the operating information included in the latest device information falls within an allowed period (S303).

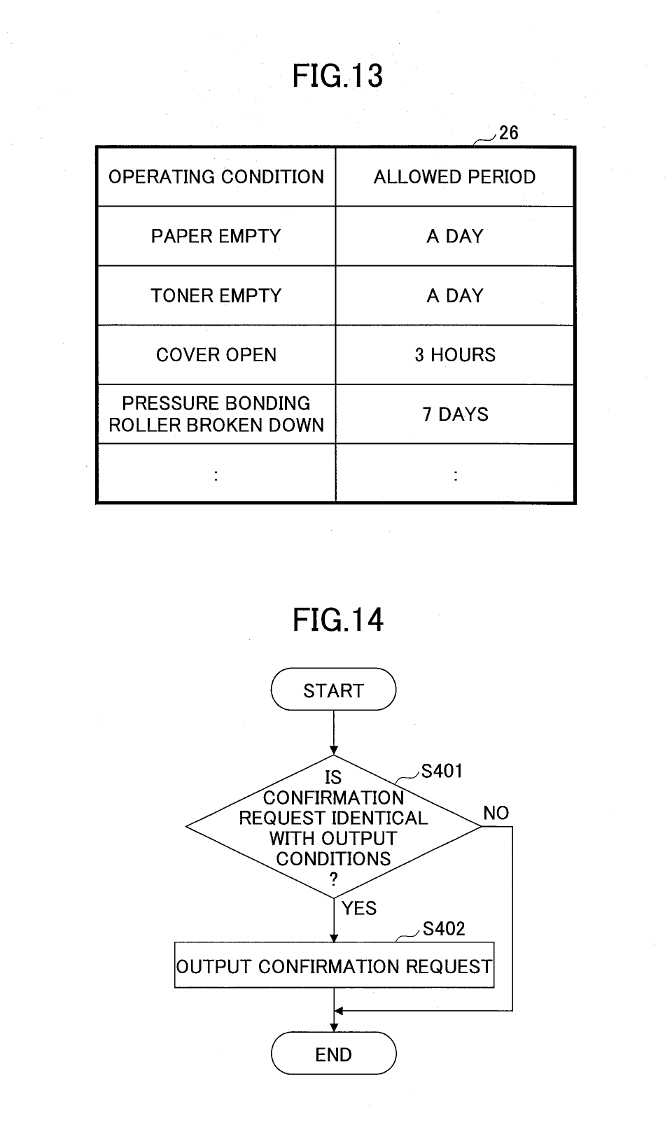

FIG. 13 is a table including information stored in the allowed period storage part 26. In FIG. 13, the allowed period storage part 26 stores the allowed period for each abnormal operating condition. The allowed period may be defined based on the contract such as the SLA. Alternatively, the allowed period may be set to a time generally required to solve the operation condition.

When the continuance period of the latest operating condition fall within the allowed period (Yes in the step S303), the confirmation necessity determination part 23 determines that the confirmation of the asset information is not required (S304). Also, when the asset status is not “working” (No in the step S302), the confirmation necessity determination part 23 determines that the confirmation of the asset information is not required (S304).

When the continuance period of the latest operating condition exceeds the allowed period (No in the step S303), the confirmation necessity determination part 23 determines that the confirmation of the asset information is required (S305). Because the asset information has not been updated regardless of the excess of the allowed period in the “working state” and the abnormal condition, the device A is possibly not actually in the “working” condition. Also, when there is no asset information for the device A (No in the step S301), the confirmation necessity determination part 23 determines that the confirmation of the asset information is required (S305).

In FIG. 12, when it is determined that the confirmation of the asset information is not required, steps S112 through S115 shown in FIG. 4 are not executed. When it is determined that the confirmation of the asset information is required, in step S112 shown in FIG. 4, a confirmation request including the asset information and the operating information indicating the latest operating condition of the device A is transmitted to the confirmation request output part 24. However, when it is determined that the confirmation of the asset information is required due to the lack of the asset information for the device A, a confirmation request including the device ID of the device A and information representing that there is no asset information for the device A is transmitted to the confirmation request output part 24.

FIG. 12 shows an example in which the confirmation request is transmitted only when the asset status is “working. However, if it is determined that a combination of the asset status and the operating condition includes inconsistency, the confirmation request may be made, for example. Information representing such combinations may be stored in the auxiliary storage 102, for example. Thus, considering the case explained with the flowchart, the confirmation request may be transmitted based on whether the asset status and the working statues indicate a predetermined relationship.

Subsequently, the details of step S115 shown in FIG. 14 are discussed. FIG. 14 is a flowchart showing a process to output the confirmation request.

In S401, the confirmation request output part 24 determines whether the cause of the confirmation request transmitted from the confirmation necessity determination part 23 is identical with any of output conditions stored in the output condition storage part 27.

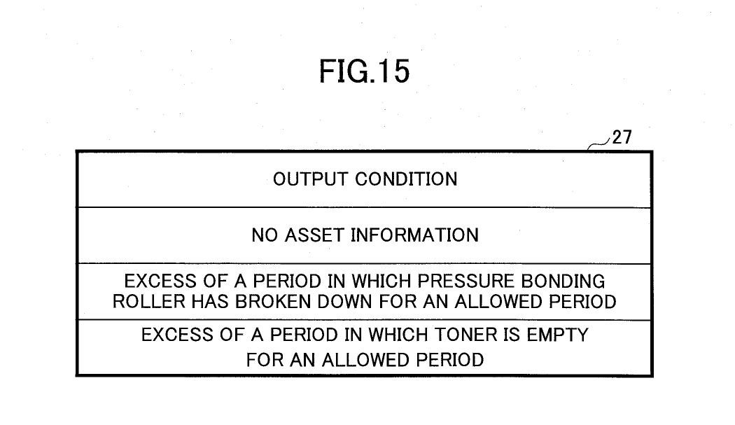

FIG. 15 is a table including information stored in output conditions storage part. In FIG. 15, the output conditions stores information to limit the confirmation request to be reported to the user. In FIG. 15, the output conditions include the following:

No asset information;

Excess of a period in which pressure bonding roller has broken down over an allowed period; and

Excess of a period in which toner is empty over an allowed period.

Thus, when the cause of the confirmation request is either the excess of a period in which pressure bonding roller has broken down over an allowed period or the excess of a period in which toner is empty over an allowed period, it is determined that the cause of the confirmation request is not identical with the output condition.

When the cause of the confirmation request is identical with the output condition (Yes in the step S401), the confirmation request output part 24 outputs the confirmation request according to a predetermined way to output (e.g. transmission of an e-mail or posting for a Web site) (S402). When the cause of the confirmation request is not identical with the output condition (No in S401), the confirmation request is not output.

By filtering the confirmation request according to the output condition, it may be prevented from outputting useless confirmation requests for a user.

As discussed above, according to this embodiment, a period in which the vendor does not have a duty to maintain the device 30 may be specified with the asset information, and the period may be excluded from a period to be used to calculate the availability rate of the device 30. Thus, the adequacy of the calculation result for the availability rate may be improved.

Note that the device information collection part is an example of a reception part in this embodiment. The asset information acquisition part is an example of an acquisition part. The maintenance status determination part 13 is an example of a first determination part or a determination part. The confirmation necessity determination part 23 is an example of a second determination part. The confirmation request output part 24 is an example of an output part. The asset information storage part 25 is an example of a storage part.

Various kinds of embodiments are discussed above, but this invention is not limited to the embodiments. Various modifications and replacement may occur to those skilled in the art without departing from the spirit and scope of the invention.

The present application is based upon and claims the benefit of priority of Japanese Patent Application No. 2013-142393 filed on Jul. 8, 2013, the entire contents of which are incorporated herein by reference.

### Patent Document

[Patent Document 1] Japanese Laid-open Patent Publication No. 2009-075644

What is claimed is:

1. An information processing system comprising:
an asset management apparatus; and
a device management apparatus; wherein
the asset management apparatus includes
a storage part configured to store asset information representing an asset status of a device as an asset, and
the device management apparatus includes
a reception part configured to repeatedly receive operating information representing an operating condition of the device,
an acquisition part configured to acquire the asset information from the asset management apparatus, and
a determination part configured to determine whether to exclude a first period in which the asset status is a predetermined status from a second period for calculating an availability rate of the device based on the received operating information.

2. The information processing system as claimed in claim 1, wherein the determination part is configured to determine that the first period is excluded from the second period regardless of the operating condition represented by the operating information when the asset information represents the predetermined status.

3. The information processing system as claimed in claim 1, further comprising:
an identification part configured to identify one of relationships defined based on the operating condition and the asset status, and determine whether the identified one of the relationships is a predetermined relationship; and
an output part configured to output a confirmation request for the asset information when the identification part determines that the identified one of the relationships is the predetermined relationship.

4. The information processing system as claimed in claim 3, wherein the output part is configured to, when the asset status is a status other than the predetermined status and a period in which the operation condition is not changed exceeds a predetermined period, output the confirmation request for the asset information.

5. A device management apparatus comprising:
a reception part configured to repeatedly receive operating information representing an operating condition of a device;
an acquisition part configured to acquire asset information representing an asset status of the device as an asset from a storage part storing the asset information; and
a determination part configured to determine whether to exclude a first period in which the asset status is a predetermined status from a second period for calculating an availability rate of the device based on the received operating information.

6. An asset management apparatus comprising:
an identification part configured to identify one of relationships defined based on the operating condition represented by the operating information received from the device management apparatus as claimed in claim 5 and the asset status stored in the storage part and determine whether the identified one of the relationships is a predetermined relationship; and
an output part configured to output a confirmation request for the asset information when the identification part determines that the identified one of the relationships is a predetermined relationship.

7. A method executed by the device management apparatus as claimed in claim 5, comprising:
repeatedly receiving operating information representing an operating condition of a device;
acquiring asset information representing an asset status of the device as an asset from a storage part storing the asset information; and
determining whether to exclude a first period in which the asset status is a predetermined status from a second period for calculating an availability rate of the device based on the received operating information.

8. A method executed by the asset management apparatus as claimed in claim 6, comprising:
identifying one of relationships defined based on the operating condition represented by the operating information received from the device management apparatus as claimed in claim 5 and the asset status stored in the storage part and determine whether the identified one of the relationships is a predetermined relationship; and
outputting a confirmation request for the asset information when the identification part determines that the identified one of the relationships is a predetermined relationship.
